(19) United States
(12) Patent Application Publication
(10) Pub. No.: US 2020/0402338 A1
(43) Pub. Date: Dec. 24, 2020

(54) EDGE COMPUTING-BASED THEFT MITIGATION SYSTEM

(71) Applicant: Bank of America Corporation, Charlotte, NC (US)

(72) Inventors: Heather Dolan, Sarasota, FL (US); Stephen T. Shannon, Charlotte, NC (US); William August Stahlhut, The Colony, TX (US); Siten Sanghvi, Jersey City, NJ (US); Crystal M. Sundaramoorthy, Charlotte, NC (US); Kevin A. Delson, Woodland Hills, NC (US); Ryan Davis, Charlotte, NC (US)

(21) Appl. No.: 16/448,078

(22) Filed: Jun. 21, 2019

(51) Int. Cl. G07C 9/00; G06Q 40/02; H04W 4/20; B42D 25/29

(52) U.S. Cl. CPC G07C 9/00912; G06Q 40/02; G06K 9/00308; B42D 25/29; G07C 2009/00579; H04W 4/20

(57) ABSTRACT

Apparatus and methods are provided for a system for tracking a movement of a dollar bill. The apparatus may include a dollar bill. The dollar bill may include an embedded sensor. The sensor may be embedded in a thickness of the bill. The sensor may have a thickness of less than 0.0043 inches. The sensor may include a memory for storing data and a transmitter. The apparatus may also include a receiver positioned on a brick and mortar banking center. The receiver may be configured to detect data transmitted from the bill and a direction of movement of the bill.

### FIELD OF TECHNOLOGY

Aspects of the disclosure relate to providing enhanced lock box security systems and methods. Aspects of the disclosure also relate to apparatus and methods for providing the tracking of a bill.

### BACKGROUND

Stand-alone brick and mortar banks typically offer a free lock box to their customers having a minimum account balance, and also allow their customers to purchase the use of a lock box if they so desire. These lock boxes are used by bank customers to store their valuables in a safe and secure manner.

However, with the passage of time, some customers forget about their lock boxes. Other customers who have grown elderly and added authorized users to their lock box are vulnerable to having these authorized users removing items from their lock box without their permission. Furthermore, a bank may desire to have an accounting of assets stored in their lock boxes for logistic and security purposes.

It would be desirable, therefore, to provide systems and methods for tracking historical usage of each of a bank's lock boxes to provide customers with timely reminders. It would also be desirable to record each opening of a lock box and what was taken while the lock box was open in order to notify the lock box owner of the opening and ensure that the owner is aware of the access. It would be further desirable to provide systems and methods for a bank to make an accounting of assets stored in its lock boxes.

Also, it would be desirable to provide systems and methods for embedding a sensor in a thickness of a bill to enable the movement of the bill to be tracked. This is desirable at least to enable law enforcement to pinpoint movement of stolen money and, alternately or additionally, to allow a financial institution to track the movement of each of its bills for security purposes.

### SUMMARY OF THE DISCLOSURE

Apparatus and methods are provided for an enhanced security system. The apparatus may include a smart lock box. The lock box may have an interior, an exterior, and a door that, when opened, allows access to the interior. The lock box may include a scale positioned on a bottom surface of the interior. The scale may be configured to measure a weight of items stored in the lock box. The lock box may also include one or more volume sensors in the interior. The volume sensors in the interior may be configured to measure a volume of items stored in the lock box.

The lock box may further include a light source. The light source may illuminate the interior when a door of the lock box is opened. The lock box may further include a camera. The camera may be used to take at least a first picture of the interior immediately upon the opening of the door of the lock box and a second picture of the interior once the door has been closed.

The lock box may additionally include a door sensor. The door sensor may be embedded on the door of the lock box. The door sensor may detect each time the door of the lock box is opened. The lock box may include an electronically-activated lock. The electronically-activated lock may be positioned on the door of the lock box. The electronically-activated lock may be configured to lock the lock box upon receipt of a message from an edge device. When the lock box is locked by the electronically-activated lock, the lock box may not be opened with a key.

The apparatus may also include an edge computing device. The edge computing device may be in electronic communication with one or more of the scale, the one or more volume sensors, the camera, the door sensor, the electronically-activated lock and a banking platform.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with principles of the invention;

FIG. 2 shows illustrative apparatus in accordance with principles of the invention;

FIG. 3 shows illustrative apparatus in accordance with principles of the invention

FIG. 4 shows illustrative apparatus and methods in accordance with principles of the invention

FIG. 5 shows illustrative apparatus in accordance with principles of the invention

FIG. 6 shows illustrative apparatus in accordance with principles of the invention

FIG. 7 shows illustrative methods in accordance with principles of the invention

### DETAILED DESCRIPTION

Apparatus and methods are provided for an enhanced security system. The apparatus may include a smart lock box. The lock box may have an interior, an exterior, and a door that, when opened, allows access to the interior.

The lock box may include a scale positioned on a bottom surface of the interior. The scale may measure a weight of items stored in the lock box. The lock box may also include one or more volume sensors in the interior. The volume sensors in the interior may measure a volume of items stored in the lock box. The volume sensors may use infrared rays, sound waves, or any other suitable waves to track a volume of the contents in the lock box. The lock box may further include a light source. The light source may illuminate the interior when a door of the lock box is opened.

The lock box may further include a camera. The camera may be used to take at least a first picture of the interior immediately upon the opening of the door of the lock box and a second picture of the interior once the door has been closed. The lock box may additionally include a door sensor. The door sensor may be embedded on the door of the lock box, on a hinge of the door of the lock box, or on any other suitable location on the lock box. The door sensor may detect each time the door of the lock box is opened. The lock box may include an electronically-activated lock. The electronically-activated lock may be positioned on the door of the lock box. The electronically-activated lock may lock the lock box upon receipt of a message from an edge device. When the lock box is locked by the electronically-activated lock, the lock box may not be opened with a key.

The apparatus may also include an edge computing device. The edge computing device may be in electronic communication with one or more of the scale, the one or more volume sensors, the camera, the door sensor, the electronically-activated lock and a banking platform. The edge computing device may include a processor for running one or more routines, memory for storing data, a receiver and a transmitter, and any other suitable software and hardware for performing the methods described herein.

In some embodiments the edge computing device may be embedded on the lock box. In some embodiments the edge computing device may be positioned in a vault in which the lock box is located.

The vault may include a plurality of lock boxes. Each lock box may have its own edge device. A single edge device may be connected to two, five, ten, twenty, or all of the lock boxes in the vault. Each edge device that is connected to one, two, or more lock boxes in the vault may include the apparatus, and perform the methods, described below in relation to a single lock box.

The edge computing device may create a data entry in a memory of the edge computing device each time the lock box is opened. Each data entry may include one or more of a date and time that the lock box is opened, a weight and volume of the items in the lock box before and after the lock box was opened, the pictures taken by the camera when the lock box was opened, and any other suitable data.

The edge computing device may determine whether or not the lock box has been opened for a threshold period of time. Exemplary threshold period of times includes 6 months, 1 year, 2 years, 3 years, 4 years, 5 years, 10 years, or any other suitable period of time. If the lock box has been opened in less than the threshold period of time, the edge device may take no action. If the lock box has not been opened for at least the threshold period of time, the edge device may instruct the banking platform to send a notification to an owner of the lock box.

The banking platform may send an electronic notification to the owner of the lock box by text, phone call, e-mail, or any other suitable method of communication. The notification may request the owner to send back to the banking platform a confirmation that the owner has received the notification. If the banking platform does not receive a receipt confirmation from the owner, the banking platform may transmit a notification to the edge device.

In the event that the edge device receives a communication from the banking platform that the owner has not responding to the notification, the edge device may activate the electronically-activated lock on the door. Activation of the electronically-activated lock may prevent access to the lock box. The electronically-activated lock may use magnetic forces, electricity, activate an additional lock different from the lock box's keyed lock, or use any other suitable method for locking the lock box such that the keyed lock on the lock box is unable to provide access to the lock box.

The apparatus may include the banking platform. The edge device may transmit each data entry created during an opening of the lock box, as described above, to the banking platform. The banking platform may store the data entry in a database. The banking platform may display some or all of the data stored in the data entry on an online banking account of the owner of the lock box. This may give the owner comprehensive knowledge of all activity taking place at his lock box.

In some embodiments, the edge device may determine a change in the weight of the items in the lock box before and after the door is opened. If the change in weight is determined to be greater than a threshold value, the edge device may instruct the banking platform to transmit a notification to the owner of the lock box. If the change in weight less determined to be less than the threshold value, the edge device may take no action. The threshold value may be selected by the owner of the lock box. The threshold value may be predetermined by the banking platform.

In some embodiments, the edge device may determine a change in the volume of the items in the lock box before and after the door is opened. If the change in volume is determined to be greater than a threshold value, the edge device may instruct the banking platform to transmit a notification to the owner of the lock box. If the change in volume less determined to be less than the threshold value, the edge device may take no action. The threshold value may be selected by the owner of the lock box. The threshold value may be predetermined by the banking platform.

In some embodiments, the banking platform may periodically check an age of an owner of a lock box. When the banking platform determines that an owner of a lock box has an age over a threshold value, the banking platform may periodically check if the owner's address is a retirement home. The banking platform may execute this determination by comparing the owner's new address to publically available records listing addresses of retirement homes. In the event that the banking platform determines that the owner resides in a retirement home, the banking platform may instruct the edge device to activate the electronically activated lock. The banking platform may subsequently generate a notification to the owner requesting the owner to provide the banking platform with any new guidelines that the owner wishes to be applied to his lock box.

The banking platform may also periodically check publicly available data to determine if the owner has died. If the banking platform determines that the owner has died, the banking platform may instruct the edge device to activate the electronically activated lock. This may ensure that authorized users of the lock box do not access the lock box and remove its contents contrary to the deceased order's wishes in a will or what a court would rule in probate.

The lock box may include a biometrics sensor. The biometrics sensor may be positioned on an outer face of the lock box. The biometrics sensor may be in electronic communication with the edge device. The edge device may store, in a database, biometric data of the owner of the lock box and, when applicable, biometric data of each authorized user of the lock box.

In some embodiments, the electronically-activated lock on the door may be activated by the edge device until the edge device receives, from the biometrics sensor, data identifying a biometrics entry received on the biometrics sensor that identifies either the owner of the lock box or an authorized user of the lock box.

In the event that biometric data received by the biometrics sensor and transmitted to the edge device is determined, by the edge device, to identify an authorized user and not the owner, the edge device may instruct the banking platform to transmit a notification to the owner of the lock box. The banking platform may transmit a notification to the owner that an authorized user has accessed his lock box and, in some embodiments, an identify of the authorized user.

In the event that biometric data received by the biometrics sensor and transmitted to the edge device is determined, by the edge device, to identify neither an authorized user nor the owner, the edge device may not deactivate the electronically-activated lock sensor. The edge device may store the biometrics data and transmit it to the banking platform with a warning notification indicating that an unauthorized access to a lock box was attempted.

The banking platform may transmit a notification to the edge device upon receipt of a message from the owner of the lock box that the owner has lost his key to the lock box. The edge device, upon receipt of the message, may activate the electronically-activated lock. The electronically-activated lock may be activated until receipt of a message from the banking platform to deactivate the electronically-activated lock. The banking platform may transmit this message after a new key has been delivered to, and received by, the owner of the lock box.

The edge device may support wireless communication. The edge device may have an internet connection. The edge device may communicate electronically with the banking platform via the internet connection.

The edge device may receive, from the banking platform, a mobile phone number associated with the lock box. If the lock box door detects an attempted opening, the edge device may transmit a message to the mobile phone number. The edge device may transmit the message using NFC or Wi-Fi. The edge device may transmit a message to an e-mail address of the owner over the internet. If a reply to the message is received by the edge device, the edge device may deactivate the electronically-activated lock. If a reply message is not received by the edge device, the edge device not deactivate electronically-activated lock.

The lock box may include one or more bills in the interior. In some embodiments, some or all of the bills in the lock box may include a sensor. The lock box may include a transmitter. The transmitter may power the sensors embedded in the bills. The lock box may also include a receiver. The receiver may receive from each of the sensors data identifying a denomination of a bill attached to the sensor. The receiver and transmitter may be part of a smart sensor or any other suitable computing device.

The edge device may gather the data received from the receiver. The edge device may sum the values of the denominations. The edge device may transmit to the banking platform the sum. In the embodiments when each lock box in a vault has its own receiver and transmitter for powering the sensor on the bill, and each lock box is connected to an edge device, or each lock box is associated with an edge device that monitors two or more lock boxes, the banking platform may be able to have an exact count of the amount of funds being stored in its lock boxes.

In the embodiments when each lock box in a vault has its own edge device, or each lock box is associated with an edge device that monitors two or more lock boxes, the banking platform may be able to calculate what percentage of its lock boxes are filled based on volume data calculated for each of the lock boxes.

The systems and methods of the invention may include a smart vault. The smart vault may provide enhanced recording and monitoring of lock box and customer activity in the vault. An interior of the vault may include one or more of a plurality of lock boxes, each lock box including an electronically-activated lock, a video camera, at least one light source, a biometrics sensor for receiving biometric information from a customer, an infrared heat sensor for monitoring body heat of the customer, a facial expression scanner and any other suitable apparatus. The smart vault may include a computing device in electronic communication with one or more of the biometrics sensor, infrared heat sensor, facial expression scanner and/or the plurality of lock boxes.

The plurality of lock boxes in the vault may not have keyed openings. The plurality of lock boxes in the vault may have keyed openings. In the embodiments when lock boxes have keyed openings, the electronically-activated lock, when activated, may not allow a user to access the lock box with a key that fits into the keyed opening.

When a customer enters the vault, the light source may automatically turn on. The camera may start recording when the customer enters and stops recording after the customer leaves. The infrared heat sensor may be activated when the customer enters the vault, and may monitor heat emitted by the customer's body. The facial expression scanner may be activated when the customer enters the vault, and may scan and analyze the customer's facial expression for anxiety or stress. In some embodiments the facial expression scanner may be fed the video being taped by the video camera and analyze the face of the customer from the video.

The customer, in the vault, may be required to provide biometric data to the biometrics sensor. The biometrics sensor may receive from the customer the customer biometric data.

The computing device may be configured to determine if the heat emitted is less than a threshold value. The computing device may be configured to determine if the analyzed facial expression does not include a threshold amount of anxiety or stress. The computing device may associate the received biometrics data with at least one of the plurality of lock boxes. If the computing device determines that the heat emitted is less than the threshold value and the analyzed facial expression does not include the threshold amount of anxiety or stress, the computing device may instruct the at least one of the plurality of lock boxes to de-activate their electronically-activated lock. The computing device may instruct one or more edge devices in accordance with the invention to de-active the at least one of the plurality of lock boxes. In some embodiments, the computing device may be an edge device described herein.

The computing device may be in electronic communication with the banking platform. In some embodiments, after a customer exits the vault, the computing device may transmit to the banking platform the recorded video data. The computing device may also transmit to the banking platform and an identifier identifying a lock box accessed while the customer was in the vault. The banking platform may post the video on an online banking page of the owner of the lock box. This may give the owner of the lock box comprehensive knowledge of the usage of his lock box, who used it, and what was taken at the time of the access.

The apparatus and methods of the invention may include apparatus for tracking the movement of a dollar bill. The apparatus may include a dollar bill. The dollar bill may include an embedded sensor. The embedded sensor may be a data transfer device. The sensor may be embedded in a thickness of the bill. The sensor may have a thickness of less than 0.0043 inches.

The sensor may include a memory for storing data and a transmitter for transmitting data. The memory may store an identifier identifying the bill. In embodiments when the Federal Government embeds the sensor in the bill at the time of the manufacturing of the bill, the Federal Government may assign an identifier to each bill and store, in a memory, the identifier and bill data associated with the bill.

The sensor may not have an energy source and may be a passive device. The sensor may have an energy source and may be an active device.

The sensor may have capabilities to connect to Wi-Fi. When the sensor connects to Wi-Fi, the sensor may transmit stored data.

The sensor may support wireless data communication using LoRaWAN.

The sensor may be a near-field communications chip, an RFID tag, an IoT device, a nanochip, a nanomachine, or a plurality of nanomachines that together form a nanonetwork.

The apparatus may include a tracking device. The tracking device may include a receiver and, in some embodiments, such as when the sensor is a passive device, a transmitter for powering the sensor. The tracking device may be positioned on a brick and mortar banking center. The tracking device may be positioned inside the brick and mortar banking center, on the outer walls of the brick and mortar sensor, on a lamp post adjacent the brick and mortar sensor, on an ATM located next to the brick and mortar sensor, or at any other suitable location.

The tracking device may be configured to transmit wireless energy for energizing the sensor when the sensor is positioned proximal to the tracking device. The tracking device may be configured to receive data transmitted from the bill. The tracking device may also track a direction of movement of the bill. The data gathered by the tracking device may be used by law enforcement personnel to track the movement of a criminal who has stolen money from the bank, the stolen money including the sensor.

The apparatus may include a shared clearing house. The shared clearing house may connect a plurality of banks. In the event that a bundle of money is stolen, the tracking device may transmit to the plurality of banks, over the shared clearing house, the unique identifier received by the tracking device from the sensor. The other banks may employ their own tracking devices having characteristics of the tracking device detailed above to locate the stolen money.

The apparatus may include apparatus for tracking in real-time a movement of the bill. The apparatus may be positioned on one or more of a truck, an automated teller machine, a point of sale device, a police car, a mobile phone, and/or any other suitable objects. The apparatus positioned on the aforementioned objects may include a transmitter configured to transmit energy that, when received by the sensor, powers the sensor and enables the sensor to transmit data, and a receiver configured to receive the data transmitted by the sensor. The apparatus may be the tracking device detailed above.

In some embodiments, the sensor described above may be embedded, additionally or alternatively, into a wrapper positioned around a stack of bills. The sensor may include the apparatus, and perform the methods, described above in connection with the sensor embedded in the bill.

In some embodiments, some or all of a plurality of bills may have the sensors described above. In these embodiments, a truck, ATM, vault, or other devices may have one or more tracking devices for receiving data from the sensors and, thus, being able to tally and track the movement of the plurality of bills on a bill-by-bill level.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

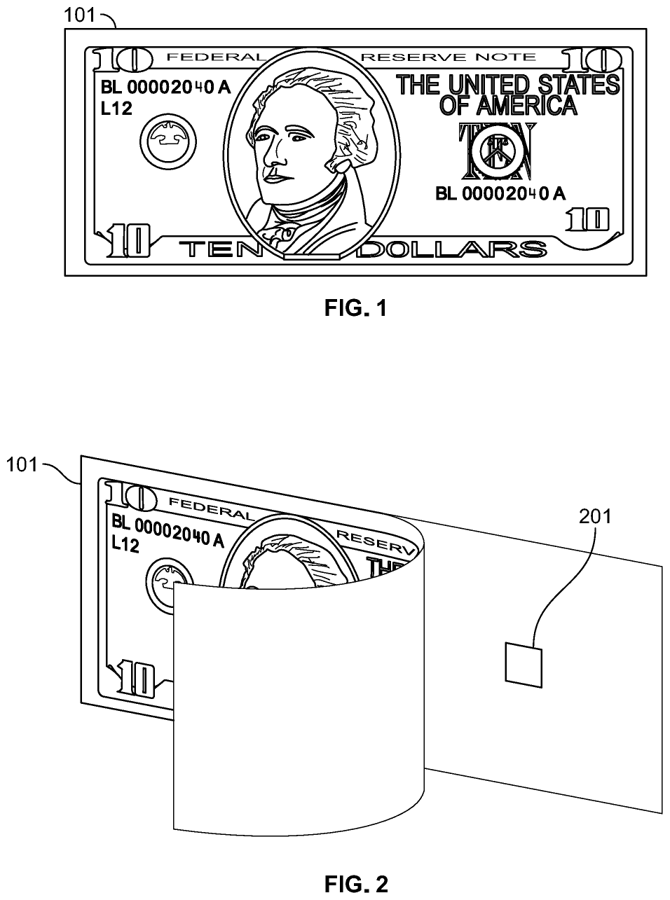

FIG. 1 shows exemplary bill 101 in accordance with the invention. The bill may have a length of 6.14 inches, a width of 2.61 inches, a thickness of 0.0043 inches, and a weight of approximately 1 gram. The bill may have a length of approximately 6.14 inches, a width of approximately 2.61 inches, a thickness of approximately 0.0043 inches, and a weight of approximately 1 gram. For the purposes of the application the term “approximately” indicates +/−5% of a value.

The bill is illustrated as a 10-dollar bill, but the systems and methods described herein may be applied to a 1-dollar bill, 2-dollar bill, 5-dollar bill, 20-dollar bill, 100-dollar bill, 500-dollar bill, 1,000-dollar bill or any other suitable denomination.

FIG. 2 shows apparatus 201 embedded in dollar bill 101. Apparatus 201 may be the sensor. Apparatus 201 may be a data transfer device, an RFID chip, an NFC chip, an IoT device, or any other type of sensor detailed above. Apparatus 201 may be an active device and have its own power source. Apparatus 201 may be passive and may be activated when receiving power from a transmitter. Apparatus 201 may have any of the features described herein in relation to apparatus embedded in a thickness of a bill.

Apparatus 201 may be embedded in the bill such that the presence of apparatus 201 in the bill is not recognizable by the eye. As such, apparatus 201 may have a thickness of less than 0.0043 inches, the thickness of the bill. This may frustrate a bad actor's attempt to identify the presence of apparatus 201 in bill 101.

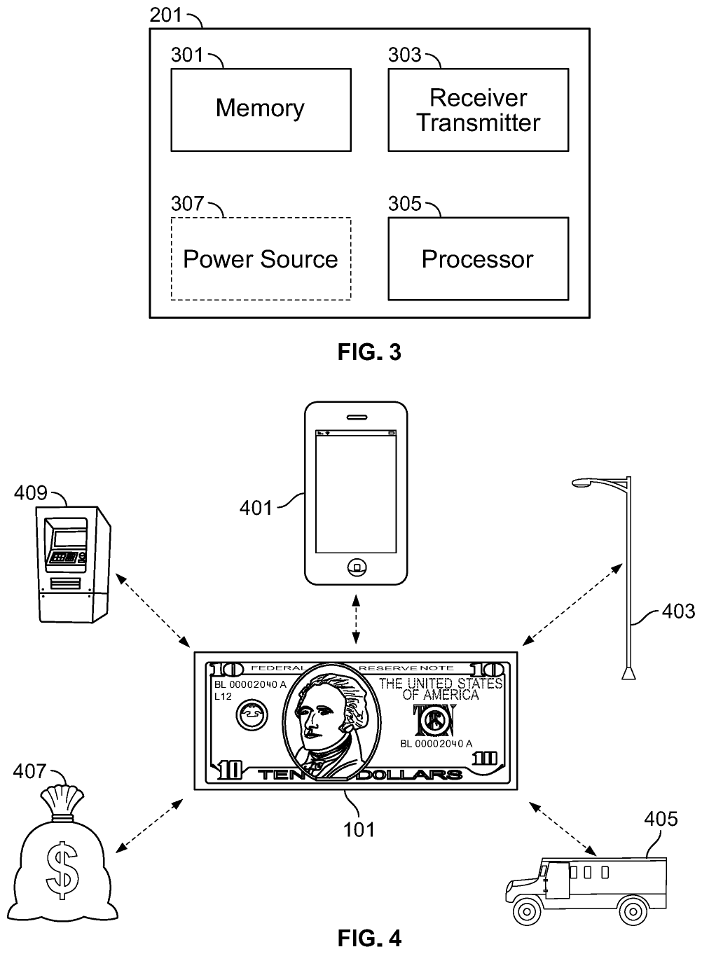

FIG. 3 shows exemplary components of apparatus 201. Apparatus 201 may include memory 301, receiver/transmitter 303, processor 305 and, optionally, power source 307. Apparatus 201 may include any other suitable hardware or software components known to those skilled in the art to support apparatus 201's functionalities described herein.

FIG. 4 shows an exemplary smart city. In the smart city illustrated in FIG. 4, bill 101 is shown being in wireless communication with mobile phone 401, lamp post 403, truck 405, truck 405, money bag 407 and ATM 409. A smart city in accordance with the invention may include a subset of the illustrated objects and, in some embodiments, additional objects not illustrated.

In the embodiments where apparatus 201 is a passive apparatus, each of mobile phone 401, lamp post 403, truck 405, truck 405, money bag 407 and ATM 409 may transmit wireless signals which may power bill 101 to transmit data to each of mobile phone 401, lamp post 403, truck 405, truck 405, money bag 407 and ATM 409. Data transmitted by bill 101 to the objects in the smart city may be one or more pieces of data transmitted by the sensor as described herein.

In the embodiments where apparatus 201 is an active apparatus, bill 101 may transmit data to each of mobile phone 401, lamp post 403, truck 405, truck 405, money bag 407 and ATM 409. Data transmitted by bill 101 to the objects in the smart city may be one or more pieces of data transmitted by the sensor as described herein.

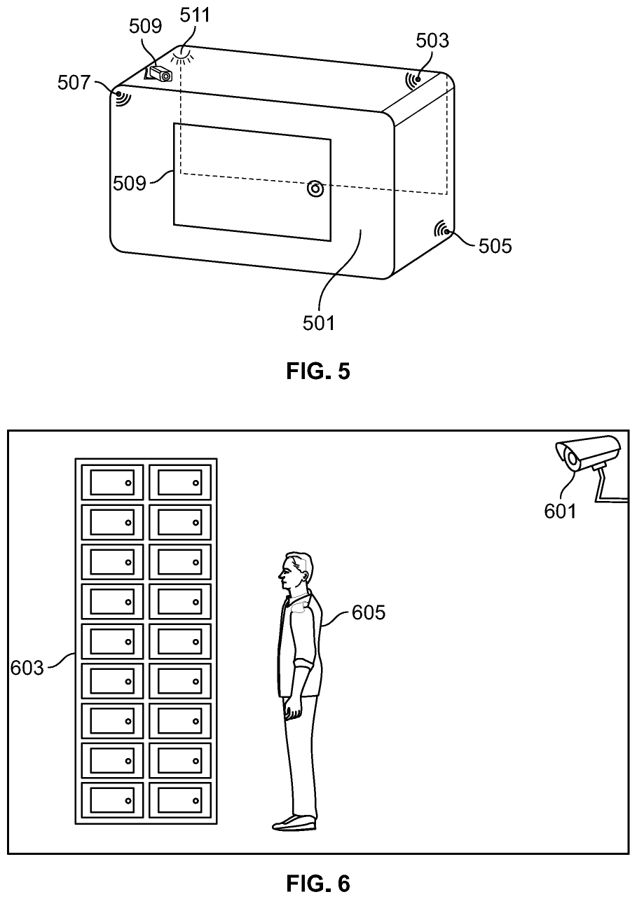

FIG. 5 shows an exemplary lock box in accordance with the invention. The lock box may include scale 501 for measuring a weight of objects stored in the lock box. The lock box may include sensors 505, 503 and 507 for calculating a volume of items stored in the lock box. The lock box may include additional sensors in each of the corners of the lock box or along the sides or roof of the lock box for calculating the volume (not shown). The lock box may include light source 511. Light source 511 may be illuminated when the lock box is open.

The lock box may include door 509. Door 509 may include a sensor that senses each time door 509 is opened. Door 509 may include an electronically-activated lock (not shown). The electronically-activated lock may lock door 509 and prevent the opening of the lock box by the lock box's key. The electronically-activated lock may lock door 509 in the event that the owner of the lock box has reported a lost key, the owner of the lock box has moved to an old age home or has died, or any other suspicious activity has been identified by the systems and methods of the invention.

The lock box may also include camera 509. Camera 509 may take one or more pictures while door 509 is open. The lock box may also include a video camera (not shown). The video camera may take a video of the contents of the lock box while door 509 is open.

FIG. 6 shows an exemplary view of a smart vault in accordance with the invention. The smart vault may include video camera 601 and lock boxes 603. Person 605 is illustrated standing in the smart vault.

Smart vault may also include one or more of a biometrics sensor, heat sensor, and facial expression scanner (not shown) to authenticate the identity of person 605, measure person 605's body heat and determine if person 605's facial expressions show fear or anxiety.

When person 605 walks into the smart vault, person 605 may be required to provide his biometrics which are then analyzed. Smart vault may send the biometric data to a database to determine the identity of person 605 based on his biometric data. Smart vault may retrieve from the database a lock box identification of one or more lock boxes that person 605 is authorized to access. Smart vault may take a video of person 605 during some or all of the time that person 605 is in the smart vault. Smart vault may have two or more cameras for videoing the activity of person 605 in the smart vault.

Smart vault may send data collected by the heat sensor and facial expression scanner to a database. If the database determines that, based on the body heat and/or facial expressions of person 605 that person 605 is exhibiting nervousness that passes a threshold value, smart vault may either lock all the lock boxes, denying person 605 access to his lock box(s) and/or transmit a message to a security personnel to come to smart vault and question person 605.

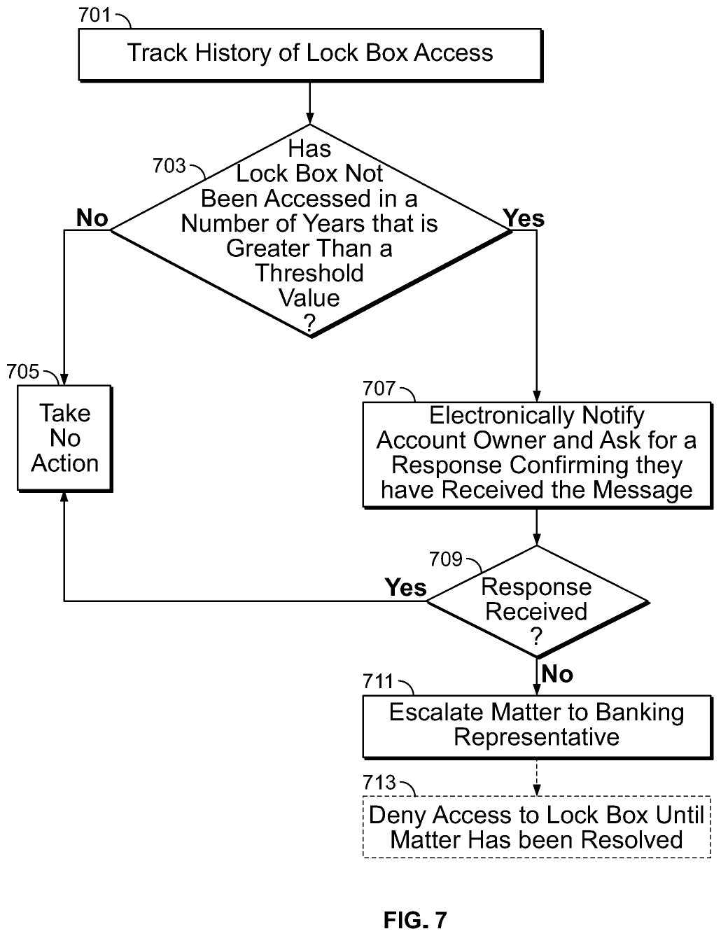

FIG. 7 shows exemplary method 700 in accordance with the invention. Method 700 may be performed by an edge device stored in a lock box. Alternately, method 700 may be performed by a central database that received from the lock box historical lock box usage information.

Method 700 may include some or all of the method steps 701-713. Method 700 may include additional method steps not described in FIG. 7 but disclosed herein. Method 700 may be performed by the edge device or central database daily, weekly, monthly, quarterly, bi-yearly, or yearly, or upon the lapse or any other suitable time period.

At step 701 the edge device may track a history of the lock box's access. For example, the edge device may record a log of each time a door of the lock box has been opened. At step 703, the edge device may determine whether or not the lock box has been accessed in a number of years that is greater than a threshold value. If the edge device determines that the lock box has been accessed in a number of years that is less than the threshold value, the edge device may take no action at step 705.

If the edge device determines that the lock box has not been accessed in a number of years that is greater than the threshold value the edge device, at step 707, the edge device may electronically notify an account owner or instruct the banking platform to notify the account owner. The notification may include a request for a response from the owner, confirming that the owner has received the message.

In the event that a response is received from the owner, the edge device may take no action at step 705. In the event that no response is received, the edge device may escalate the matter to a banking representative at step 711. Optionally, at step 713, the lock box may deny access to the lock box until the matter has been resolved. For example, the edge device may tag a warning notification to the lock box once the threshold number of years have passed without the lock box being accessed and the owner has not responded to the notification. Until the edge device receives an instruction to remove the warning notification, the edge device may activate an electronically-activated lock on the lock box that shuts down the lock box and does not enable the lock box to be opened by the lock box's key.

Thus, systems and methods for providing enhanced lock box and vault features and bill tracking systems and methods are provided. Persons skilled in the art will appreciate that the present invention can be practiced by other than the described embodiments, which are presented for purposes of illustration rather than of limitation.

What is claimed is:

1. Apparatus including:
a smart lock box having an interior, exterior, and a door that, when opened, allows access to the interior, the lock box including:
a scale positioned on a bottom surface of the interior, the scale being configured to measure a weight of items stored in the lock box;
one or more volume sensors in the interior for measuring a volume of items stored in the lock box;
a light source for illuminating the interior when a door of the lock box is opened;
a camera for taking at least a first picture of the interior immediately upon the opening of the door of the lock box and a second picture of the interior once the door has been closed;
a door sensor embedded on the door to detect each time it is opened; and
an electronically-activated lock on the door configured to lock the lock box upon receipt of a message from the edge device wherein, when the lock box is locked down, the lock box cannot be opened with a key; and
an edge computing device, the edge computing device being in electronic communication with each of the scale, one or more volume sensors, camera, door sensor, electronically-activated lock, and a banking platform.

2. The apparatus of claim 1 wherein the edge computing device is configured to create a data entry in a memory of the edge computing device each time the lock box is opened, each data entry including a date and time that the lock box is opened, a weight and volume of the items in the lock box before and after the lock box was opened, and the pictures taken by the camera when the lock box was opened.

3. The apparatus of claim 2 wherein the edge computing device is configured to:
determine whether or not the lock box has been opened for a threshold period of time;
if the lock box has not been opened for the threshold period of time, instructing the banking platform to send a notification to an owner of the lock box; and
if the edge device receives a communication from the banking platform that the owner has not responding to the notification, activating the electronically-activated lock on the door to prevent any access to the lock box.

4. The apparatus of claim 1 wherein the edge computing device is embedded on the lock box.

5. The apparatus of claim 1 further comprising the banking platform, wherein:
the edge device sends each data entry to the banking platform; and
the banking platform stores the data entry in a database and displays data stored in the data entry on an online banking account of the owner of the lock box.

6. The apparatus of claim 1 wherein the edge device is configured to:
determine a change in the weight of the items in the lock box before and after the door is opened; and
if the change in weight is greater than a threshold value, instructing the banking platform to transmit a notification to the owner of the lock box.

7. The apparatus of claim 1 wherein the edge device is configured to:
determine a change in the volume of the items in the lock box before and after the door is opened; and
if the change in volume is greater than a threshold value, instructing the banking platform to transmit a notification to the owner of the lock box.

8. The apparatus of claim 3 wherein the banking platform is configured to:
periodically check an age of an owner of a lock box; and
when an owner of a lock box is determined to have an age over a threshold value:
periodically check if the owner's address is a retirement home and, if the owner's address is a retirement home, instruct the edge device to activate the electronically activated lock; and
periodically check publicly available data to determine if the owner has died, and, if the owner has died, instruct the edge device to activate the electronically activated lock.

9. The apparatus of claim 1 wherein:
the lock box includes on an outer face of the lock box a biometrics sensor;
the biometrics sensor is in electronic communication with the edge device; and
the edge device stores, in a database, biometric data of the owner of the lock box and each authorized user of the lock box.

10. The apparatus of claim 9 wherein:
the electronically-activated lock on the door is activated by the edge device until the edge device receives, from the biometrics sensor, data identifying a biometrics entry received on the biometrics sensor that identifies either the owner of the lock box or an authorized user of the lock box; and
if biometric data received by the edge device identifies an authorized user and not the owner, the edge device is configured to instruct the banking platform to transmit a notification to the owner of the lock box.

11. The apparatus of claim 5 wherein:
the banking platform is configured to transmit a notification to the edge device upon receipt of a message from the owner of the lock box that the owner has lost his key to the lock box; and
the edge device, upon receipt of the message, is configured to activate the electronically-activated lock.

12. The apparatus of claim 1 wherein:
the edge device supports wireless communication;
the edge device is configured to receive, from the banking platform, a mobile phone number associated with the lock box; and
if the door detects an attempted opening, the edge device is configured to:
transmit a message to the mobile phone number;
if a reply message is received by the edge device, deactivate the electronically-activated lock; and
if a reply message is not by the edge device, not deactivate the electronically-activated box.

13. The apparatus of claim 1 wherein:
the lock box includes one or more bills in the interior;
each of the bills includes a sensor;
the lock box includes a transmitter configured to power the sensors and a receiver to receive from each of the sensors data identifying a denomination of a bill attached to the sensor.

14. The apparatus of claim 13 wherein the edge device is configured to gather the data received from the receiver, sum the values of the denominations, and transmit the sum to the banking platform.

15. A smart vault providing enhanced recording and monitoring of lock box and customer activity in the vault, an interior of the vault including:
a plurality of lock boxes, each lock box including an electronically-activated lock, the plurality of lock boxes not having keyed openings;
a video camera;
at least one light source;
a biometrics sensor for receiving biometric information from a customer;
an infrared heat sensor for monitoring body heat of the customer;
a facial expression scanner; and
a computing device in electronic communication with the biometrics sensor, infrared heat sensor, facial expression scanner and the plurality of lock boxes;
wherein, when a customer enters the vault:
the light source automatically turns on;
the camera begins recording when the customer enters and stops recording after the customer leaves;
the infrared heat sensor monitors heat emitted by the customer's body;
the facial expression scanner scans and analyzes the customer's facial expression for anxiety or stress;
the biometrics sensor receives from the customer biometric data; and
the computing device is configured to:
determine if the heat emitted is less than a threshold value and determine if the analyzed facial expression do not include a threshold amount of anxiety or stress;
associate the received biometrics data with at least one of the plurality of lock boxes; and
if the heat emitted is less than the threshold value and the analyzed facial expression does not include the threshold amount of anxiety or stress, instruct the at least one of the plurality of lock boxes to de-activate their electronically-activated lock.

16. The smart vault of claim 15 wherein:
the computing device is in electronic communication with a banking platform; and
after a customer exits the vault, the computing device is configured to transmit to the banking platform the video recorded data and an identifier identifying a lock box accessed while the customer was in the vault.

17. Apparatus for tracking a location of a dollar bill, the apparatus including:
the dollar bill, the dollar bill including an embedded sensor in a thickness of the bill, the sensor having a thickness of less than 0.0043 inches, wherein the sensor includes a memory for storing data and a transmitter; and
a tracking device positioned on a brick and mortar banking center, the tracking device being configured to:
transmit wireless energy for energizing the sensor when the sensor is positioned adjacent to the tracking device;
receive data transmitted from the bill; and
track a direction of movement of the bill while the sensor is adjacent the tracking device;
wherein:
when the sensor is powered by the wireless energy of the receiver, the sensor is configured to transmit a code to the tracking device, the code including a unique identifier associated with the bill.

18. The apparatus of claim 17 wherein the sensor supports wireless data communication using LoRaWAN.

19. The apparatus of claim 17 wherein the sensor is selected from a group comprising a near-field communications chip, an RFID tag, an IoT device, and a nanochip.

20. The apparatus of claim 17 further comprising apparatus for tracking in real-time a movement of the bill, the apparatus being positioned on:
a truck;
an automated teller machine;
a point of sale device;
a police car; and
a mobile phone;
wherein the apparatus positioned on each of the truck, the automated teller machine, the point of sale device, the police car and the mobile phone includes:
a transmitter configured to transmit energy that, when received by the sensor, powers the sensor and enables the sensor to transmit data; and
a receiver configured to receive the data transmitted by the sensor.
